(19) United States
(12) Patent Application Publication
(10) Pub. No.: US 2012/0045745 A1
(43) Pub. Date: Feb. 23, 2012

(54) REMOTE CLASS SERVICE SYSTEM

(75) Inventors: Young Hee LEE, Seoul (KR); Bo Ra KIM, Seoul (KR); Yun Hye JUNG, Seoul (KR); Hye Young YANG, Seongnam-si (KR)

(73) Assignee: TSTUDY CO., LTD., Seoul (KR)

(21) Appl. No.: 12/960,985

(22) Filed: Dec. 6, 2010

(30) Foreign Application Priority Data
Aug. 23, 2010 (KR) 10-2010-0081383

(51) Int. Cl. G09B 3/00

(52) U.S. Cl. 434/351

(57) ABSTRACT

Disclosed is a remote class service system, which enables active learning and lecture through bidirectional communication between a student and a lecturer who are remote from each other.

### CROSS-REFERENCE TO RELATED APPLICATION

This application claims priority from and the benefit of Korean Patent Application No. 10-2010-0081383, filed on Aug. 23, 2010, which is hereby incorporated by reference for all purposes as if fully set forth herein.

### BACKGROUND OF THE INVENTION

1. Field of the Invention

The present invention relates to a remote class service system, and more particularly to a remote class service system which enables active learning and lecture through bidirectional communication between a student and a lecturer who are remote from each other.

2. Description of the Prior Art

Nowadays, a lot of students often use online class services, such as online lectures. Conventional online class services are executed in such a manner that a student takes a class by reproducing moving lecture images previously stored in a server using his/her computer.

In such a conventional online class services, a student takes a class passively by seeing moving lecture images stored in a server. As a result, such a conventional online class service has a disadvantage in that it is impossible to execute active learning and lecture through bidirectional communication between a student and a teacher which can be executed in an offline field in such a manner that a student asks a question to a teach or the teacher answers the student.

### SUMMARY OF THE INVENTION

Accordingly, the present invention has been made to solve the above-mentioned problems occurring in the prior art, and an object of the present invention is to provide a remote class service system which enables active learning and lecture through bidirectional communication between one or more students and a lecturer.

In order to accomplish this object, there is provided a remote class service system including: an electronic class system including: a dot book printed with a dot pattern, on which lecture contents are described and one or more icons are indicated; a student electronic pen which generates and transmits student writing data by recognizing the dot pattern at the points where the student electronic pen comes into contact with the dot book; a student computer which configures a remote learning screen by implementing a remote learning application, wherein through the implementation of the remote learning application, the student computer receives the student writing data from the student electronic pen, and displays and transmits the received student writing data on the remote learning screen, and through the implementation of the remote learning application, the student computer receives lecturer input data and lecture images, and displays the received lecturer input data and lecture images on the remote learning screen; a service server which receives and transmits the student writing data from the student computer, and which receives and transmits the lecturer input data and the lecture images to the student computer; and a lecturer computer which configures a remote lecture screen by implementing a remote lecture application, wherein through the implementation of the remote lecture application, the lecturer computer receives and displays the student writing data on the remote lecture screen, and through the implementation of the remote lecture application, the lecturer computer transmits the lecturer input data and the lecture images acquired through a lecturer camera.

In accordance with another aspect of the present invention, there is provided a learning system for allowing a student to take a class by communicating with a remotely positioned lecture system, the learning system including: a student electronic pen which generates and transmits student writing data by recognizing a dot pattern at the points where the student electronic pen comes into contact with a dot book printed with the dot pattern; and a student computer which configures a remote learning screen by implementing a remote learning application, wherein the student computer receives the student writing data from the student electronic pen, and displays the received student writing data on the remote learning screen, and the student computer receives lecturer input data and lecture images, and displays the received lecturer input data and lecture images on the remote learning screen.

In accordance with another aspect of the present invention, there is provided a lecture system for allowing a lecturer to proceed with a remote lecture by communicating with a remotely positioned learning system or a student, the lecture system including: a lecturer electronic pen which generates and transmits student writing data by recognizing a dot pattern at the points where the lecturer electronic pen comes into contact with a dot book printed with the dot pattern; and a lecturer computer which configures a remote lecture screen by implanting a remote lecture application, wherein the lecturer computer receives the student writing data from the learning system, and displays the received student writing data on the remote lecture screen, and the lecturer computer transmits the lecturer input data and the lecture images acquired through a lecturer camera to the learning system.

As described above, according to the present invention, it is possible to provide a remote class service system which enables active learning and lecture through bidirectional communication between one or more students and a lecturer.

### BRIEF DESCRIPTION OF THE DRAWINGS

The above and other objects, features and advantages of the present invention will be more apparent from the following detailed description taken in conjunction with the accompanying drawings, in which:

FIG. 1 shows a remote class service system in accordance with an embodiment of the present invention;

FIG. 2 exemplifies a remote class service using the inventive remote class service system;

FIG. 3 shows the steps of generating, transmitting and displaying student writing data; and

FIG. 4 shows the steps of generating, transmitting and displaying lecturer input data.

### DETAILED DESCRIPTION OF THE PREFERRED EMBODIMENTS

Hereinafter, exemplary embodiments of the present invention will be described with reference to the accompanying drawings. In the following description, the same elements will be designated by the same reference numerals although they are shown in different drawings. Further, in the following description of the present invention, a detailed description of known functions and configurations incorporated herein will be omitted when it may make the subject matter of the present invention rather unclear.

In addition, terms, such as first, second, A, B, (a), (b) or the like may be used herein when describing components of the present invention. Each of these terminologies is not used to define an essence, order or sequence of a corresponding component but used merely to distinguish the corresponding component from other component(s). It should be noted that if it is described in the specification that one component is “connected,” “coupled” or “joined” to another component, a third component may be “connected,” “coupled,” and “joined” between the first and second components, although the first component may be directly connected, coupled or joined to the second component.

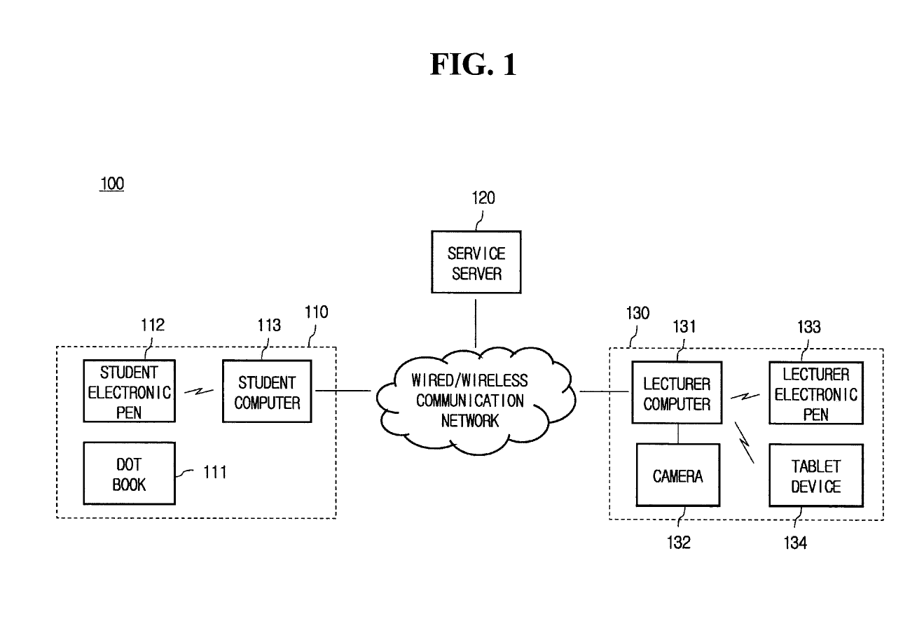

FIG. 1 shows a remote class service system 100 in accordance with an embodiment of the present invention.

Referring to FIG. 1, the remote class service system 100 in accordance with an embodiment of the present invention includes a learning system 110 to be used by a student who is a learner, a lecture system 130 to be used by a lecturer, and a service server 120 interconnecting the learning system 110 and the lecturer system 130 through a wired or wireless communication network, such as a wired or wireless-based internet network or a mobile communication network, so as to provide a learning or lecture environment, wherein the service server 120 may be implemented in the form of a web server or a wap server.

The learning system 110 includes a dot book 111, which is a digital learning material, a student electronic pen 112 which is a digital writing tool, and a student computer 113 which communicates with each of the student electronic pen 112 and the service server 120.

The dot book 111 is printed with a dot pattern, and is provided with lecture contents. One or more icons are indicated on the dot book 111, which can be recognized by the student electronic pen 112, wherein the icons correspond to the functions of the electronic pen 112, respectively.

The student electronic pen 112 is a digital writing tool, wherein the student electronic pen 112 recognizes dot patterns at the points where the student electronic pen 112 comes into contact with the dot book 111 when a student executes writing on the dot book, and generates and transmits student writing data to the student computer 113.

The student electronic pen 112 stores information for the dot pattern printed on the dot book 111. The student electronic pen 112 can generate student writing data by recognizing the dot pattern at the points where the student electronic pen 112 comes into contact with the dot book using a camera or a scanner with reference to the stored dot pattern information (e.g., coordinate values of dots or the like), and by determining the writing traces of the student writing on the basis of the recognized patterns (e.g., coordinate values of dots or the like).

The student computer 113 configures a remote learning screen by implementing a remote learning application installed by the service server 120, wherein the student computer 113 displays student writing data received from the student electronic pen 112 through the implementation of the remote learning application on the remote learning screen, and displays lecturer input data and lecture images received from the service server through the implementation of the remote learning application on the remote learning screen.

The above-mentioned service server 120 receives and transmits student writing data from the student computer 113 to the lecturer computer 131, and receives and transmits lecturer input data and lecture images from the lecturer computer 131 to the student computer 113.

The above-mentioned lecture system 130 includes a lecturer computer 131 equipped with a camera 132. The lecturer computer 131 configures a remote lecture screen by implementing a remote lecture application installed by the service server 120, wherein the lecturer computer displays student writing data received from the service server through the implementation of the remote lecture application on the remote lecture screen, and transmits lecturer input data input to the lecturer system 130 and lecture images acquired through a lecturer camera to the service server 120 through the implementation of the remote lecture application.

In order to implement the inventive remote class service, the student computer 113 and the lecturer computer 131 should be provided with a remote learning application and a remote lecture application, respectively. For this purpose, the above-mentioned service server 120 installs the remote learning application in the student computer 113 after confirming the corresponding student information, and installs the remote lecture application in the lecturer computer 131 after confirming the corresponding lecturer information in a predetermined type, such as Active X.

If the remote learning application is installed in the student computer 113 and the remote lecture application is installed in the lecturer computer 131, the student computer 113 configures a remote learning screen for remote learning through the implementation of the remote learning application, and the lecturer computer 131 configures a remote lecture screen for remote lecture through the implementation of the remote lecture application.

Below, the remote learning screen and the remote lecture screen will be described in more detail.

In connection with the configuration of a remote learning screen, through the implementation of the remote learning application, the above-mentioned student computer 113 may configure a remote learning screen including an area for displaying lecture images photographed by a camera 132 mounted on the lecturer computer 131, an area for displaying lecture contents, and an area for displaying student writing data generated by and received from the student electronic pen 112 and lecturer writing data received from the service server 120.

In connection with the configuration of a remote lecture screen, through the implementation of the remote lecture application, the lecturer computer 131 may select one or more students and may configure a remote lecture screen including one or more student screens, each of which is for one of the selected students. That is, the remote lecture screen may include a single student screen for one selected student, or two or more student screens for the selected two or more students.

One or more icons may be indicated on the above-mentioned dot book 111, which can be recognized by the student electronic pen 112, and correspond to the functions performed by the student electronic pen 112, respectively.

For example, a send icon may be indicated on a part where a dot pattern corresponding to the send function of the student electronic pen 112 is printed. Consequently, the student electronic pen 112 recognizes the dot pattern at the send icon-indicated point on the dot book 111, wherein when it is recognized that the send icon is pushed, the student electronic pen 112 can perform the send function corresponding to the send icon, thereby sending previously generate student writing data to the student computer 113 through wired or wireless communication.

Lecturer input data is input to the above-mentioned lecturer computer 131. Depending on whether an input device for the lecturer input data is separately provided or not, the lecturer computer 131 may be a tablet computer, to which the lecturer input data can be inputted through a touch screen, or an ordinary computer, to which the lecturer input data can be input through the separate input device.

If the lecturer computer 131 is an ordinary computer, to which the lecturer input data can be input through a separate input device, the input device may include at least one of a lecturer electronic pen 133 and a tablet device 134, wherein the lecturer electronic pen 133 generates the lecturer input data through the recognition of the dot pattern printed on the dot book, and inputs the lecturer input data to the lecturer computer 131, and the tablet device 134 consists of a pen and a specific plate, generates lecturer input data by recognizing the contact points between the lecturer electronic pen and the specific plate, and inputs the lecturer input data to the lecturer computer 131.

The above-mentioned lecturer electronic pen 133 stores information for the dot pattern printed on the dot book, wherein the lecturer electronic pen 133 can recognize the dot pattern at the points where the lecturer electronic pen 133 comes into contact with the dot book using a camera, a scanner or the like with reference to the stored dot pattern information (e.g., coordinate values of dots or the like), and can generate lecturer input data (lecturer writing data by determining writing traces for the lecturer writing on the basis of the recognized information (e.g., coordinate values of dots or the like).

Meanwhile, the above-mentioned lecturer input data may include at least one of correction data for the student writing data, and teaching program data. The correction data for the student writing data are data generated when the lecturer writes contents for correcting the student writing data using the lecturer electronic pen 133, the tablet device 134 or the tablet function of the lecturer computer 131 after the lecturer confirms, through the lecturer computer 131, the student writing data generated by the student electronic pen 112 when a student writes contents with the student electronic pen 112. The teaching program is data concerning lecture materials previously stored in the lecturer computer 131.

Meanwhile, the inventive remote class service system 100 can provide a remote class service in real time or non-real time.

In order to provide a real time class service, the service server receives lecturer input data and lecture images from the lecturer computer 131, and transmits the lecturer input data and lecture images to the student computer 113, thereby providing a real time lecture function.

In order to provide a non-real time class service, the service server 120 receives lecturer input data and lecture images from the lecturer computer 131, and generates and stores lecture record data containing the lecturer input data and the lecturer images as received, so that when a service request is received from a student computer, the lecturer computer 131 sends the stored lecture record data to the student computer 113, thereby providing a non-real time lecture function.

Meanwhile, the service server 120 can provide various functions related to learning and lecture, such as a function for managing a student's learning on the basis of the student writing data received from a corresponding student computer 113, a function for scoring and analyzing solving procedures when answers to examination questions and solving contents are contained in the student writing data, and a function for rendering lecturer's opinions to be transmitted to the student computer 113.

For example, the service server 120 stores learning result data including student writing data received from one or more student computers 113, whereby the service server 120 can manage the stored learning data by students by making the learning result data correspond to student information items. In addition, the service server 120 can search and supply the learning result data stored and managed by students in the service server 120 according to a request from one or more student computers 113, a lecturer computer 131 or another terminal.

In addition, when the student writing data received from the student computers 113 contain solving contents for examination questions, the service server 120 can perform an automatic scoring function for the solving contents for examination questions contained in the student writing data, and according to the automatic scoring results, the service server 120 can generate examination result data, and inform the learning results by sensing the generated examination result data to the student computers 113.

In addition, when sending the examination result data to the student computer 113, the service server 120 can send the lecturer input data related to the examination result data together with the examination result data. For this purpose, after sending the student writing data or the examination result data to the lecturer computer 131, the service server 120 receives, from the lecturer computer 131, the lecturer input data as solving procedure analysis data or correction data generated by the lecturer computer 131 or an input device 133 or 134 connected to the lecturer computer 131 in connection with examination questions solving contents confirmed through the student writing data or examination result contents confirmed through the examination result data, whereby the service server 120 can send the lecturer input data and the examination result data to the student computers 113 so as to provide a lecture's correction function.

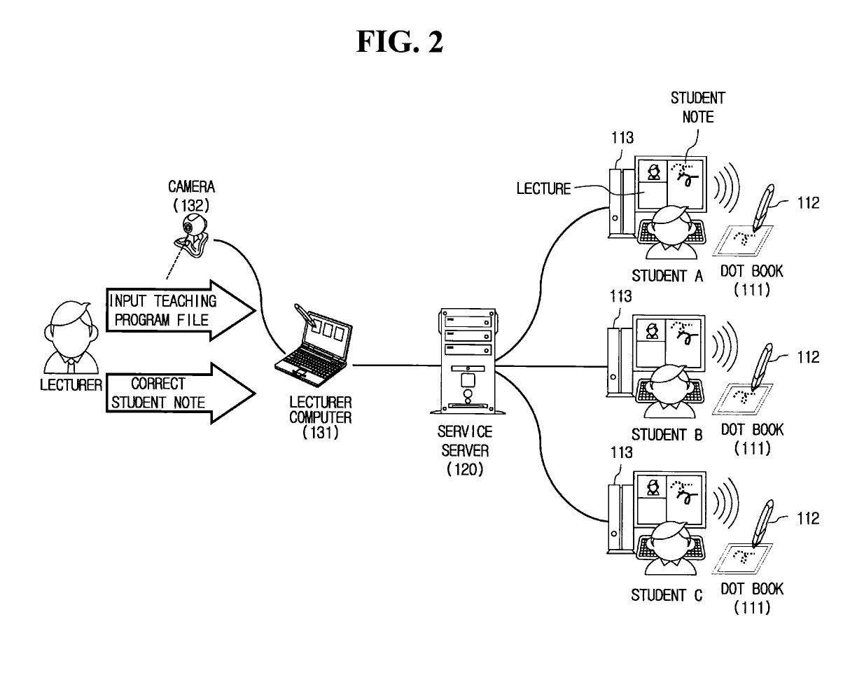

FIG. 2 shows an example of a remote class service system 100 in accordance with an embodiment of the present invention.

The inventive remote class service system 100 of FIG. 2 is made assuming that a remote class service is executed in real time between a lecturer and three students (Student A, Student B, Student C).

Referring to FIG. 2, the lecturer performs a lecture with his/her own lecturer computer 131, to which a camera 132 is connected, using the contents of a teaching program file as lecture contents, and the students watch the lecture through their student computers 113, and writes learning contents using a dot book and a student electronic pen 112 as desired.

In order for the lecturer to proceed with the lecture with the lecturer computer 131 connected to the camera 132 using the contents of teaching program file as the lecture contents, the teaching file is input to the lecturer computer 131 as lecturer input data. The contents of the teaching file, which is the lecturer input data input in this manner, are transmitted to the student computers 113 of all of the students through the service server 120, so that the contents of the teaching program are identically displayed on remote learning screens which are displayed on the monitors of the student computers 113 of all of the students, respectively. In addition, the lecture images photographed by the camera 132 are transmitted to all of the student computers 113 through the service server, so that the lecture images are identically displayed on the remote learning screens displayed on the monitors of all of the student computers 113, respectively.

Each student can take a lesson while watching the remote learning screen displayed on the monitor of his/her student computer 113, and listening to the lecture sounds through a speaker. In a case in which there is a question or solving contents for a question, if each student writes corresponding contents on his/her own dot book 111 using his/her own student electronic pen 112, the student electronic pen 112 generates student writing data by recognizing the dot pattern at the points where the student electronic pen 112 comes into contact with the dot book 111, and transmits the generated student writing data to the corresponding student computer 113. The student writing data transmitted to the student computer 113 is transferred to the lecturer computer 131 via the service server 120, and shown on the remote lecture screen of the corresponding student displayed on the monitor of the lecturer computer 131.

In addition, each student can ask a question with his/her voice. In such a case, the corresponding student computer can receive the student's voice through a microphone, and can transmit voice data for the received voice to the lecturer computer 131 through the service server 120. The voice data transmitted to the lecturer computer 130 is voice-outputted through a speaker, so that the lecturer can confirm the student's question.

In addition, each student can ask a question using a chatting program. In such a case, each of the student computers 113 and the lecturer computer 131 should be provided with a separate chatting program or such a chatting program should be supported by the installed remote learning application. The student computer 113 shows a chatting window on the screen by the chatting program, receives the question through the chatting window as an input, and then transmits input data containing the question to the lecturer computer 131 via the service server 120. The lecturer computer 131 shows the input data received from the student computer 113 on the chatting window displayed on the screen by the chatting program.

The lecturer can confirm the student's question by watching the chatting window on the monitor of the lecturer computer 131.

In order to correct an answer or opinion for the confirmed question or solving contents for a question, the lecturer writes an answer or opinion, using the tablet function of the lecturer computer 131, the tablet device 134 connected to the lecturer computer 131, or the lecturer electronic pen 133. If so, lecturer input data is generated according to the writing contents, such as the answer or opinion, by the tablet function unit of the lecturer computer 131, the tablet device 134 connected to the lecturer computer 131 or the lecturer electronic pen 133, and the generated lecturer input data is transferred from the lecturer computer 131 to the corresponding student computer 113 via the service server 120, whereby the lecturer data can be displayed on the remote learning screen.

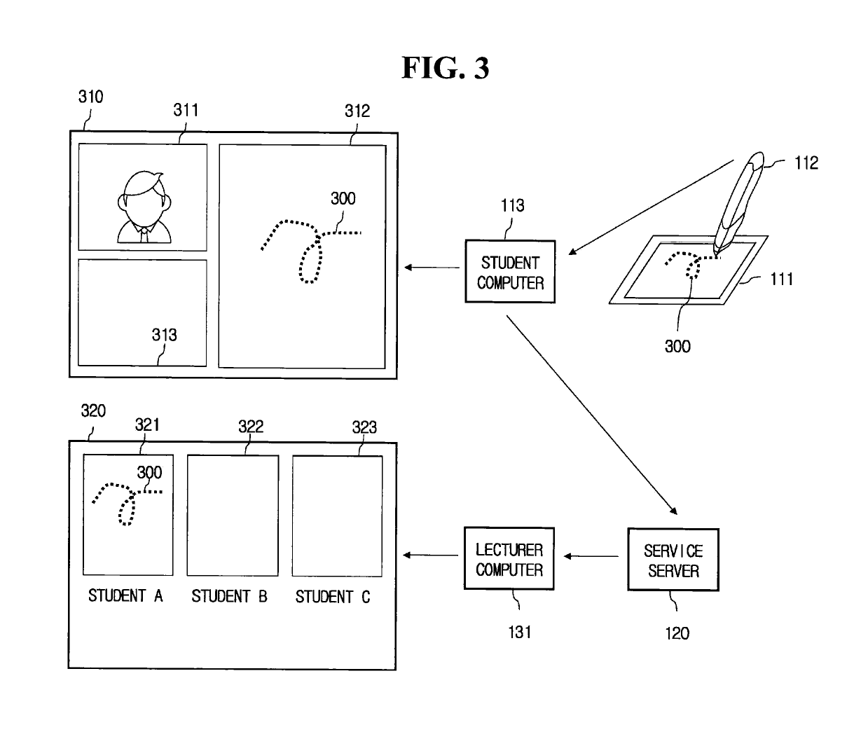

Hereinafter, with reference to FIG. 3, a description will be made, by way of an example, as to how student writing data containing the contents written by a student, using a dot book 111 and a student electronic pen 112, is generated and transferred to the corresponding student computer 113 and the lecturer computer 131, so that the transferred student writing data can be shown on the remote learning screen displayed on the monitor of the student computer 113, and on the remote lecture screen displayed on the monitor of the lecturer computer 131.

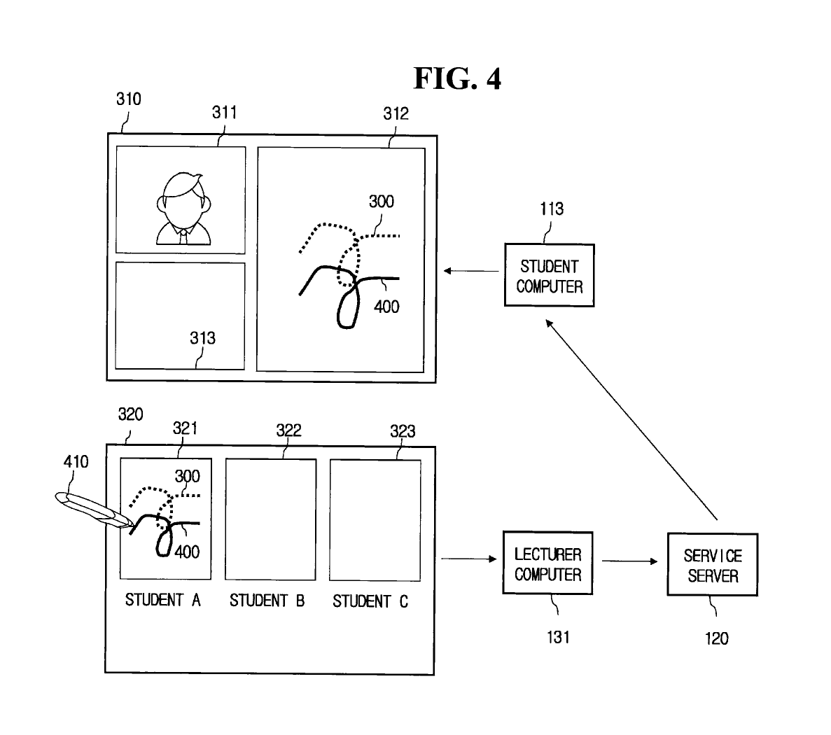

In addition, with reference to FIG. 4, a description will be made, by way of an example, as to how lecturer input data containing the contents written by the lecturer, using the tablet function of the lecturer computer 131, the tablet device 134 connected to the lecturer computer 131, or the lecturer electronic pen 133, is generated and transferred to the lecturer computer 131 and the corresponding student computer 113, so that the transferred lecturer input data can be shown on the remote lecture screen displayed on the monitor of the lecturer computer 131, and on the remote learning screen displayed on the monitor of the student computer 113.

Prior to making the above-mentioned descriptions, a remote learning screen that a student watches while taking a lesson, and a remote lecture screen 320 that a lecturer watches while giving a lecture is described in advance. Here, the remote learning screen 310 is configured by a remote learning application installed in the corresponding student computer 113, and is displayed on the monitor of the corresponding student computer 113. The remote lecture screen 320 is configured by a remote lecture application installed in the corresponding lecturer computer 131, and is displayed on the monitor of the corresponding lecturer computer 131.

As shown in FIG. 3, the remote learning screen 310 consists of an area 311 for displaying lecture image, an area 313 for displaying lecture contents, an area 312 for displaying student writing contents (i.e., the contents of student writing data) and lecturer writing contents (i.e., the contents of lecturer writing data). In addition, the remote lecture screen 320 includes sub-remote lecture screens by students taking the lecture. Reflecting the remote class service environment executed between one lecturer and three students as shown in FIG. 2, the remote lecture screen 320 includes a sub-remote lecture screen for Student A 321, a sub-remote lecture screen for Student B 322, and a sub-remote lecture screen for Student C 323.

FIG. 3 shows the steps of generating, transmitting and displaying student writing data.

Referring to FIG. 3, when a student writes contents on the dot book 111 with a student electronic pen 112, the student electronic pen 112 generates student writing data for the student's writing contents 300 by recognizing the dot pattern at the points where the student electronic pen 112 comes into contact with the dot book 111.

The student electronic pen 112 transmits the generated student writing data to the corresponding student computer 113 by a wired or wireless communication method.

Accordingly, the student computer 113 displays the writing contents 300 at an area indicated by reference numeral 312 on the remote learning screen 310 connected to the student computer 113, on the basis of the received student writing data. At the same time, the student computer 113 transmits the writing contents 300 to the lecturer computer 131.

On the basis of the received student writing data, the lecturer computer 131 displays the writing contents 300 at the sub-remote lecture screen 321 of the corresponding student on the remote lecture screen 320 on the monitor connected to the lecturer computer 131. Through this procedure, the lecturer can confirm the writing contents 300 written by the student, and can correct the confirmed contents. The steps of generating, transmitting and displaying lecturer input data according to this correction will be described below with reference to FIG. 4.

Meanwhile, the student computer 113 not only transmits the student writing data generated by and received from the student electronic pen 112 to the lecturer computer 131, but also can transmit student voice data to the lecturer computer 131 by generating student voice data from a student's voice input through a microphone or by receiving student voice data from the student electronic pen 112, wherein the finally mentioned student voice data is generated by a microphone in the student electronic pen from a student's voice received by the microphone. In addition, the student computer 113 may receive specific information from an input device, such as a keyboard or a mouse, as an input, and transmit the input specific information to the lecturer computer. Moreover, the student computer 113 may transmit images photographed through a camera connected to the student computer 113 to the lecturer computer 131. By transferring various forms of data to the lecturer through various transmission methods, the students can easily, conveniently and efficiently transfer necessary information and data, which can make it possible to execute an interactive remote class.

Referring to FIG. 4, if a lecturer writes contents using a touch tool, such as a pen, on a sub-remote lecture screen 321 of a corresponding student so as to transfer an opinion or the like for the student writing contents 300 shown on the sub-remote lecture screen 310 of the corresponding student on the remote lecture screen 320, the lecturer computer 131, which is a tablet computer, recognizes the lecturer's writing contents 400 and displays the lecturer's writing contents 400 at the sub-remote lecture screen 321 of the corresponding student, and at the same time, the lecturer computer 131 generates lecturer input data on the basis of the recognized lecturer's writing contents 400, and transmits the lecturer's input data to the student computer 113.

The student computer 113 receiving the lecturer input data confirms the lecturer's writing contents 400 from the lecturer input data, and displays the confirmed lecturer's writing contents 400 at the area indicated by reference numeral 312 on the remote class screen 310. As a result, the corresponding student can confirm the contents corrected by the lecturer.

As described above, according to the present invention, it is possible to provide a remote class service system which enables active learning and lecture through bidirectional communication (i.e., exchange of student writing data and lecturer input data) between one or more students and a lecturer.

Even if it was described above that all of the components of an embodiment of the present invention are coupled as a single unit or coupled to be operated as a single unit, the present invention is not necessarily limited to such an embodiment. That is, among the components, one or more components may be selectively coupled to be operated as one or more units. In addition, although each of the components may be implemented as an independent hardware, some or all of the components may be selectively combined with each other, so that they can be implemented as a computer program having one or more program modules for executing some or all of the functions combined in one or more hardwares. Codes and code segments forming the computer program can be easily conceived by an ordinarily skilled person in the technical field of the present invention. Such a computer program may implement the embodiments of the present invention by being stored in a computer readable storage medium, and being read and executed by a computer. A magnetic recording medium, an optical recording medium, a carrier wave medium, or the like may be employed as the storage medium.

In addition, since terms, such as “including,” “comprising,” and “having” mean that one or more corresponding components may exist unless they are specifically described to the contrary, it shall be construed that one or more other components can be included. All of the terminologies containing one or more technical or scientific terminologies have the same meanings that persons skilled in the art understand ordinarily unless they are not defined otherwise. A term ordinarily used like that defined by a dictionary shall be construed that it has a meaning equal to that in the context of a related description, and shall not be construed in an ideal or excessively formal meaning unless it is clearly defined in the present specification.

Although a preferred embodiment of the present invention has been described for illustrative purposes, those skilled in the art will appreciate that various modifications, additions and substitutions are possible, without departing from the scope and spirit of the invention as disclosed in the accompanying claims.

Therefore, the embodiments disclosed in the present invention are intended to illustrate the scope of the technical idea of the present invention, and the scope of the present invention is not limited by the embodiment.

The scope of the present invention shall be construed on the basis of the accompanying claims in such a manner that all of the technical ideas included within the scope equivalent to the claims belong to the present invention.

What is claimed is:

1. A remote class service system comprising:
an electronic class system comprising: a dot book printed with a dot pattern, on which lecture contents are described and one or more icons are indicated; a student electronic pen which generates and transmits student writing data by recognizing the dot pattern at the points where the student electronic pen comes into contact with the dot book; and a student computer which configures a remote learning screen by implementing a remote learning application, wherein through the implementation of the remote learning application, the student computer receives the student writing data from the student electronic pen, and displays and transmits the received student writing data on the remote learning screen, and through the implementation of the remote learning application, the student computer receives lecturer input data and lecture images, and displays the received lecturer input data and lecture images on the remote learning screen;
a service server which receives and transmits the student writing data from the student computer, and which receives and transmits the lecturer input data and the lecture images to the student computer; and
a lecturer computer which configures a remote lecture screen by implementing a remote lecture application, wherein through the implementation of the remote lecture application, the lecturer computer receives and displays the student writing data on the remote lecture screen, and through the implementation of the remote lecture application, the lecturer computer transmits the lecturer input data and the lecture images acquired through a lecturer camera.

2. The remote class service system as claimed in claim 1, wherein the service server installs the remote learning application to the student computer after confirming the corresponding student information, and installs the remote lecture application to the lecturer computer after confirming the corresponding lecturer information.

3. The remote class service system as claimed in claim 1, wherein the student computer configures a remote learning screen comprising an area for displaying the lecture images, an area for displaying lecture contents, and an area for displaying student writing data and lecturer writing data.

4. The remote class service system as claimed in claim 1, wherein the dot book has a send icon at a dot pattern printed part corresponding to the send function in the student electronic pen, and
wherein the student electronic pen recognizes that the send icon is pushed by recognizing the dot pattern at the point where the send icon is indicated, and sends the previously generated student writing data to the student computer in a wired or wireless communication mode.

5. The remote class service system as claimed in claim 1, wherein by implementing the remote lecture application, the lecturer computer selects one or more students and configures the remote lecture screen comprising student screens which correspond to the selected students, respectively.

6. The remote class service system as claimed in claim 1, wherein the lecturer computer is a tablet computer for receiving the lecturer input data as an input through a touch screen, or an ordinary computer for receiving the lecturer input data as an input through a separate input device, and
wherein when the lecturer computer is an ordinary computer for receiving the lecturer input data as an input through a separate input device, the input device includes at least one of a lecture electronic pen which generates and inputs the lecturer input data to the lecturer computer through the recognition of the dot pattern printed on the dot book, and a tablet device which consists of a pen and a specific plate, and generates and inputs the lecturer input data to the lecturer computer by recognizing the contact points between the pen and the specific plate.

7. The remote class service system as claimed in claim 1, wherein the lecturer input data includes at least one of correction data for the student writing data and the teaching program data.

8. The remote class service system as claimed in claim 1, wherein after receiving the lecturer input data and the lecture images from the lecturer computer, the service server provides a real time lecture function by transmitting the received lecturer input data and the lecture images in real time, or provides a non-real time lecture function by generating lecture record data containing the received lecturer input data and lecture images, and transmitting the stored lecture record data to the student computer when a service request is received from the student computer.

9. The remote class service system as claimed in claim 1, wherein the service server stores the student writing data received from the student computer in a state in which it is contained in learning result data, and managing the learning result data to correspond to student information items by students, respectively.

10. The remote class service system as claimed in claim 1, wherein when solving contents for examination questions are contained in the student writing data, the service server performs an automatic scoring function for the solving contents for examination questions contained in the student writing data, thereby generating examination result data, and transmits the examination result data to the student computer.

11. The remote class service system as claimed in claim 10, wherein after transmitting the student writing data or the examination result data to the lecturer computer, the service server receives the lecturer input data as solving procedure analysis data or correction data, and transmits the lecturer input data and the examination result data to the student computer.

12. A learning system for allowing a student to take a class by communicating with a remotely positioned lecture system, the learning system comprising:
a student electronic pen which generates and transmits student writing data by recognizing a dot pattern at the points where the student electronic pen comes into contact with a dot book printed with the dot pattern; and
a student computer which configures a remote learning screen by implementing a remote learning application, wherein the student computer receives the student writing data from the student electronic pen, and displays the received student writing data on the remote learning screen, and the student computer receives lecturer input data and lecture images, and displays the received lecturer input data and lecture images on the remote learning screen.

13. A lecture system for allowing a lecturer to proceed with a remote lecture by communicating with a remotely positioned learning system or a student, the lecture system comprising:
a lecturer electronic pen which generates and transmits student writing data by recognizing a dot pattern at the points where the lecturer electronic pen comes into contact with a dot book printed with the dot pattern; and
a lecturer computer which configures a remote lecture screen by implanting a remote lecture application, wherein the lecturer computer receives the student writing data from the learning system, and displays the received student writing data on the remote lecture screen, and the lecturer computer transmits the lecturer input data and the lecture images acquired through a lecturer camera to the learning system.
